(19) United States
(12) Patent Application Publication
(10) Pub. No.: US 2024/0392930 A1
(43) Pub. Date: Nov. 28, 2024

(54) METHODS AND IOT SYSTEMS FOR SMART GAS PIPELINE ZONING SAFETY SUPERVISION

(71) Applicant: CHENGDU QINCHUAN IOT TECHNOLOGY CO., LTD., Chengdu (CN)

(72) Inventors: Zehua SHAO, Chengdu (CN); Junyan ZHOU, Chengdu (CN); Yaqiang QUAN, Chengdu (CN); Lei ZHANG, Chengdu (CN)

(73) Assignee: CHENGDU QINCHUAN IOT TECHNOLOGY CO., LTD., Chengdu (CN)

(21) Appl. No.: 18/795,119

(22) Filed: Aug. 5, 2024

(30) Foreign Application Priority Data
Jul. 8, 2024 (CN) 202410907121.8

(51) Int. Cl. F17D 5/06; F17D 5/00; G06Q 50/06

(52) U.S. Cl. CPC F17D 5/06; F17D 5/005; G06Q 50/06

(57) ABSTRACT

Disclosed is a method and Internet of Things (IoT) system for smart gas pipeline zoning safety supervision, the method includes: determining a plurality of sub-regions by dividing a target region based on a gas pipeline distribution data in the target region; obtaining gas sensor data of each point in the plurality of sub-regions on the gas pipeline; determining, based on the gas sensor data and pipeline data, an actual leakage point on the gas pipeline; determining, based on the gas sensor data and a historical maintenance record, a potential hidden danger point on the gas pipeline. The IoT system includes a government supervision management platform, a government supervision sensor network platform, a government supervision object platform, a gas company sensor network platform, and a gas device object platform that interact in sequence.

### CROSS-REFERENCE TO RELATED APPLICATION

This application claims priority of Chinese Patent Application No. 202410907121.8 filed on Jul. 8, 2024, the contents of which are entirely incorporated herein by reference.

### TECHNICAL FIELD

The present disclosure relates to a field of gas pipeline leakage monitoring, and in particular, to a method and Internet of Things system for smart gas pipeline zoning safety supervision.

### BACKGROUND

Gas pipelines are mostly buried in the ground, and after leakage, a great amount of combustible gas may be generated directly or indirectly and spread to surrounding rainwater pipeline networks, sewage pipeline networks, and other municipal manholes. As the rainwater pipeline, sewage pipeline, and other municipal manholes are interconnected, the gas may spread along the pipeline for several kilometers. When a concentration reaches an explosion limit, a great-scale serial explosion may occur upon encountering an ignition source. There is therefore a need to regulate gas pipelines.

Aiming at the problem of how to regulate gas pipelines, CN110107815B proposes a gas pipeline leakage detection method and device, which detects the concentration of combustible gases in an underground space around a plurality of gas pipelines and determines whether the concentration of the combustible gases satisfies the leakage condition. However, the detection of the combustible gas concentration often occurs only when the gas pipeline has been damaged, resulting in the leakage of the combustible gas to a certain extent, which means a hysteretic nature of the detection. Moreover, potential hidden danger points may not be detected and handled in time.

Therefore, it is desired to provide an improved method and system for smart gas pipeline zoning safety supervision, which can predict the points where the leakage actually occurs and the points where the leakage is likely to occur, so as to facilitate timely warnings and maintenance.

### SUMMARY

One or more embodiments of the present disclosure provide a method for smart gas pipeline zoning safety supervision. The method may include: determining a plurality of sub-regions by dividing a target region based on a gas pipeline distribution data in the target region; obtaining gas sensor data of each point in the plurality of sub-regions on a gas pipeline in the target region from a plurality of gas company management platforms through a government gas supervision sensor network platform; determining, based on the gas sensor data and pipeline data, an actual leakage point on the gas pipeline; determining, based on the gas sensor data and a historical maintenance record, a potential hidden danger point on the gas pipeline; in response to an existence of the actual leakage point, generating, based on an actual position of the actual leakage point on the gas pipeline, a first maintenance instruction and a first adjustment instruction; and sending the first maintenance instruction to the gas company management platform corresponding to the actual position to instruct the gas company management platform to dispatch maintenance personnel to repair the actual position; and sending the first adjustment instruction to a gas pipeline control device corresponding to the actual position to adjust a working parameter of the gas pipeline control device; and in response to an existence of the potential hidden danger point, generating, based on a potential position of the potential hidden danger point on the gas pipeline, a second maintenance instruction and a second adjustment instruction; and sending the second maintenance instruction to the gas company management platform corresponding to the potential position to instruct the gas company management platform to dispatch the maintenance personnel to check the potential position; and sending the second adjustment instruction to a gas pipeline monitoring device corresponding to the potential position to adjust a monitoring parameter of the gas pipeline monitoring device.

One of the embodiments of the present disclosure provides an IoT system for smart gas pipeline zoning safety supervision. The system may include a government supervision management platform, a government supervision sensor network platform, a government supervision object platform, a gas company sensor network platform, and a gas device object platform that interact in sequence, and the government supervision management platform may include a government gas supervision and management platform and a government safety supervision and management platform; the government supervision sensor network platform may include a government gas supervision sensor network platform and a government safety supervision sensor network platform; the government gas supervision and management platform may be configured to: determine a plurality of sub-regions by dividing a target region based on a gas pipeline distribution data in a the target region; obtain gas sensor data of each point in the plurality of sub-regions on a gas pipeline in the target region from a plurality of gas company management platforms through the government gas supervision sensor network platform; determine, based on the gas sensor data and pipeline data, an actual leakage point on the gas pipeline; determine, based on the gas sensor data and a historical maintenance record, a potential hidden danger point on the gas pipeline; in response to an existence of the actual leakage point, generating, based on an actual position of the actual leakage point on the gas pipeline, a first maintenance instruction and a first adjustment instruction; send the first maintenance instruction to the gas company management platform corresponding to the actual position to instruct the gas company management platform to dispatch maintenance personnel to repair the actual position; and send the first adjustment instruction to the gas pipeline control device corresponding to the actual position to adjust a working parameter of the gas pipeline control device; and in response to an existence of potential hidden danger point, generating, based on a potential position of the potential hidden danger point on the gas pipeline, a second maintenance instruction and a second adjustment instruction; and send the second maintenance instruction to the gas company management platform corresponding to the potential position to instruct the gas company management platform to dispatch the maintenance personnel to check the potential position; and send the second adjustment instruction to a gas pipeline monitoring device corresponding to the potential position to adjust a monitoring parameter of the gas pipeline monitoring device.

One or more embodiments of the present disclosure provide a non-transitory computer-readable storage medium storing computer instructions, when executing the computer instructions in the non-transitory computer-readable storage medium, a computer implements the method for smart gas pipeline zoning safety supervision.

In the present disclosure, by determining the actual leakage point and the potential hidden danger point, performing maintenance to the actual leakage point, and reducing the gas pressure of the pipeline at the leakage point, the gas leakage may be dealt with in a timely manner, and safety risk due to the gas leakage may be reduced. Further, by checking the potential hidden danger point and increasing the monitoring frequency of the relevant monitoring devices, it may be ensured that the potential hidden danger points are repaired in a timely manner and adequately monitored, thus effectively preventing the occurrence of gas leakage.

### BRIEF DESCRIPTION OF THE DRAWINGS

The present disclosure will be further illustrated by way of exemplary embodiments, which will be described in detail with reference to the accompanying drawings. These embodiments are not limiting, and in these embodiments, the same counting denotes the same structure, wherein:

FIG. 1 is a schematic diagram illustrating a structure of an Internet of Things (IoT) for smart gas pipeline zoning safety supervision according to some embodiments of the present disclosure;

FIG. 2 is a flowchart illustrating an exemplary method for smart gas pipeline zoning safety supervision method according to some embodiments of the present disclosure;

FIG. 3 is a schematic diagram illustrating an exemplary process for determining sub-regions and a management mapping relationship according to some embodiments of the present disclosure;

FIG. 4 is a schematic diagram illustrating an exemplary process for determining the actual leakage point according to some embodiments of the present disclosure; and

FIG. 5 is a schematic diagram illustrating a structure of a hidden danger point estimation model according to some embodiments of the present disclosure.

### DETAILED DESCRIPTION

To order to more clearly illustrate the technical solutions of the embodiments of the present disclosure, the following will briefly describe the accompanying drawings that need to be used in the description of the embodiments. Obviously, the accompanying drawings in the following description are only some examples or embodiments of the present disclosure, and it is possible for a person of ordinary skill in the art to apply the present disclosure to other similar scenarios based on these drawings without creative labor. Unless obviously obtained from the context or the context illustrates otherwise, the same numeral in the drawings refers to the same structure or operation.

It should be understood that the terms “system,” “device,” “unit” and/or “module” as used herein are a way to distinguish between different components, elements, parts, sections, or assemblies at different levels. However, if other words accomplish the same purpose, the terms may be replaced by other expressions.

As shown in the present disclosure and in the claims, unless the context clearly suggests an exception, the words “a,” “one,” “an,” and/or “the” do not refer specifically to the singular, but may also include the plural. Generally, the terms “including” and “comprising” suggest only the inclusion of clearly identified steps and elements, and these steps and elements do not constitute an exclusive list. The method or apparatus may also include other steps or elements.

Flowcharts are used in the present disclosure to illustrate operations performed by a system according to embodiments of the present disclosure. It should be appreciated that the preceding or following operations are not necessarily performed in exact order. Instead, steps may be processed in reverse order or simultaneously. Also, it may add other operations to these processes or remove a step or steps from these processes.

Often, one or more detection devices may be pre-installed near a gas pipeline for detecting whether a leakage occurs in the gas pipeline. For example, a sensor may be pre-buried to detect a gas concentration, etc. However, there may be a certain hysteretic nature in a use of the detection device, and leaks may often be detected only after they occur. Moreover, it takes time from the detection of the leakage in the gas pipeline to a time when the staff goes to the site for in situ maintenance, which increases a safety risk.

In view of the above, some embodiments of the present disclosure are expected to provide an improved method and Internet of Things (IoT) smart gas pipeline zoning safety supervision. By determining actual leakage points and potential hidden danger points on the gas pipeline, measures may be timely taken when the leakage occurs on a gas pipeline, and corresponding maintenance measures may be taken for the potential hidden danger points to prevent the potential hidden danger points from leaking.

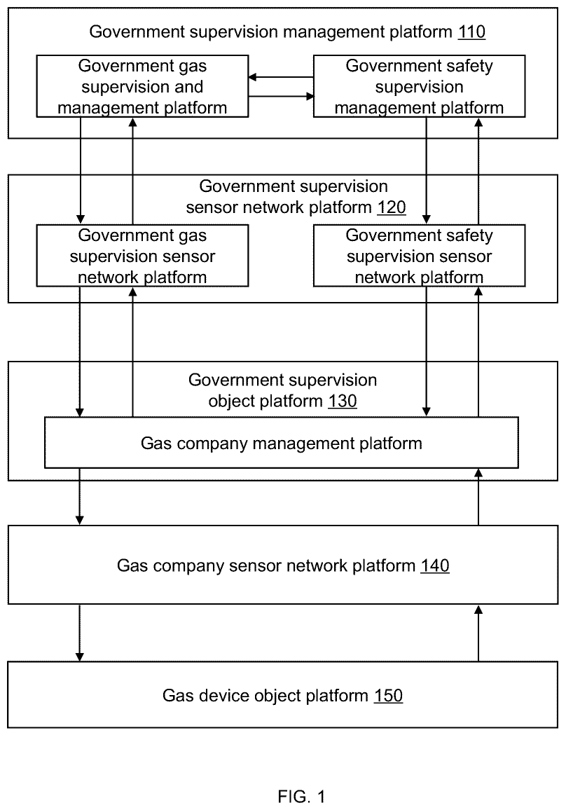

FIG. 1 is a schematic diagram illustrating a structure of an IoT system smart gas pipeline zoning safety supervision according to some embodiments of the present disclosure.

As shown in FIG. 1, the IoT system for smart gas pipeline zoning safety supervision may include a government supervision management platform 110, a government supervision sensor network platform 120, a government supervision object platform 130, a gas company sensor network platform 140, and a gas device object platform 150 that interact in sequence.

The government supervision management platform 110 may be configured as a platform used by a government to integrate and coordinate linkage and collaboration between various functional platforms, aggregate all the information of the IoT, and provide perception management and control management functions for operation and maintenance of the gas pipeline.

In some embodiments, the government supervision management platform 110 may include a government gas supervision and management platform and a government safety supervision and management platform, which respectively analyze and process gas-related data and gas pipeline safety-related data.

In some embodiments, the government supervision management platform 110 may perform information interactions with the government supervision sensor network platform 120.

The government supervision sensor network platform 120 may be configured as a functional platform for the government to manage sensor communications. In some embodiments, the government supervision sensor network platform 120 may perform functions of a perceptual information sensor communication and a control information sensor communication. In some embodiments, the government supervision sensor network platform 120 may be configured to interact with the government gas supervision and management platform and a gas company management platform. In some embodiments, the government supervision sensor network platform 120 may include a government gas supervision sensor network platform and a government safety supervision sensor network platform, which are respectively used to obtain information about operation and status of a gas pipeline-related device and a gas pipeline safety-related device.

In some embodiments, the government supervision sensor network platform 120 may perform a bi-directional information interaction with the government supervision management platform 110 as well as the government supervision object platform 130. For example, the government supervision management platform 110 may issue a data obtaining instruction to the gas company management platform via the government supervision sensor network platform 120, and the gas company management platform, after obtaining the data obtaining instruction, may upload gas sensor data to the government supervision management platform 110 via the government supervision sensor network platform 120.

The government supervision object platform 130 may be a platform for the government to generate monitoring information and perform control information. In some embodiments, the government supervision object platform 130 may include the gas company management platform.

In some embodiments, the gas company management platform may receive the gas sensor data uploaded by the gas company sensor network platform 140 and upload the gas sensor data to the government supervision sensor network platform 120 when receiving a data obtaining instruction issued by the government supervision sensor network platform 120; and the gas company management platform may further receive a first maintenance instruction and/or a second maintenance instruction issued by the government supervision management platform 110 via the government supervision sensor network platform 120, generate a dispatch task based on the first maintenance instruction and/or the second maintenance instruction, and issue the dispatch task to maintenance personnel for dispatching the maintenance personnel to carry out maintenance on a target sub-region. More descriptions of the gas sensor data, the maintenance instruction, and the dispatch task may be found in the following contents.

In some embodiments, each gas company may have a corresponding gas company management platform.

The gas company sensor network platform 140 refers to a functional platform for an integrated management of the sensor communications by the gas company.

In some embodiments, the gas company sensor network platform 140 may perform the information interaction with the gas device object platform 150 and the gas company management platform in a bi-directional manner. For example, the gas company sensor network platform 140 may upload the gas sensor data, etc. to the gas company management platform, which is obtained from the gas device object platform 150.

The gas device object platform 150 refers to a functional platform for perceptual information generation and controlling information execution. In some embodiments, the gas device object platform 150 may include a gas pipeline monitoring device. The gas device object platform 150 may interact with the gas company sensor network platform 140.

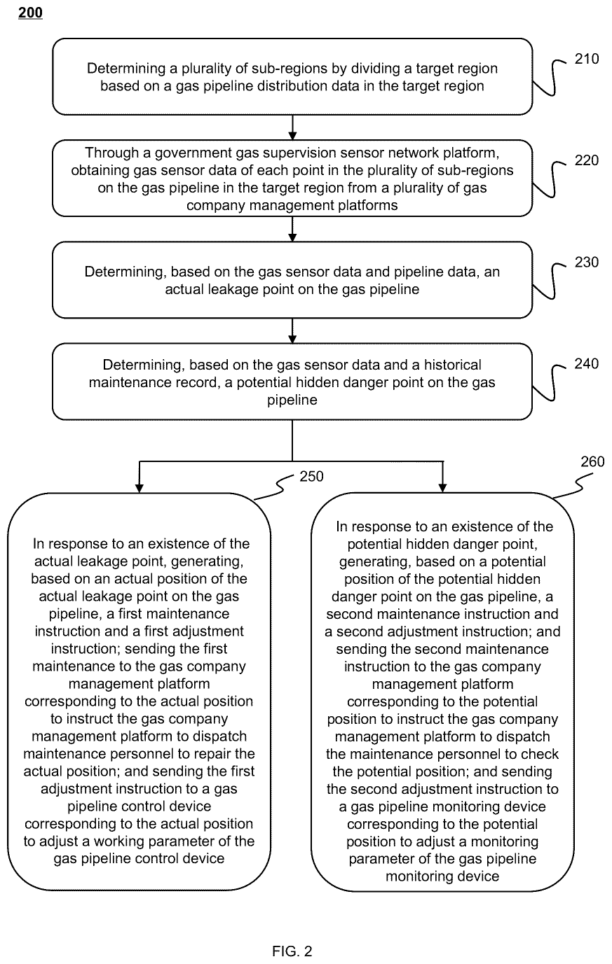

The gas pipeline monitoring device may be a device for monitoring information related to the gas pipeline, and the gas pipeline monitoring device may at least include a temperature sensor, a humidity sensor, a flow rate sensor, and a pressure sensor. Exemplarily, the gas pipeline monitoring device may be deployed in the gas pipeline in a region to be monitored, and may be used to monitor gas the sensor data in the gas pipeline, and upload the obtained gas sensor data via the gas device object platform 150 to the gas company sensor network platform 140. For more about the aforesaid platform, please refer to FIG. 2 to FIG. 4 and the related descriptions.

In some embodiments, the smart gas pipeline zoning safety supervision system may also include a multi-level network, e.g., a first-level network and a second-level network, etc. For example, the first-level network may include a smart gas first-level network management platform, a smart gas first-level network sensor network platform, and a smart gas first-level network object platform. For another example, the second-level network may include a smart gas second-level network management platform, a smart gas second-level sensor network platform, and a gas second-level network object platform.

In some embodiments of the present disclosure, the smart gas company management platform may obtain multi-dimensional data from other platforms, so as to improve the accuracy of pipeline assessment of a sub-region, and enable a pipeline corridor to make faster and more accurate adjustments in case of emergency. In addition, the IoT system may integrate a plurality of platforms such as the gas company management platform, the gas device object platform 150, and the government supervision management platform 110, and may form a closed loop of information operation between the platforms. An effective synergistic operation between the platforms may help to improve informatization and intelligence of the smart gas pipeline zoning safety supervision. Comprehensively, the system may enhance the regulatory capacity, safety, and management efficiency of the pipeline zoning through intelligent data management and collaborative decision-making.

FIG. 2 is a flowchart illustrating an exemplary method for smart gas pipeline zoning safety supervision according to some embodiments of the present disclosure. As shown in FIG. 2, a process 200 may include the following steps. In some embodiments, the process 200 may be performed by a government gas supervision and management platform.

Step 210, determining a plurality of sub-regions by dividing a target region based on a gas pipeline distribution data in the target region.

The target region refers to a gas pipeline distribution region that requires a zoning supervision. For example, a district of a city may be used as the target region.

The gas pipeline distribution data refers to data information related to a distribution of the gas pipeline. In some embodiments, the gas pipeline distribution data may include a sparse distribution of the gas pipeline, a count of the gas pipeline, a length, a thickness, a direction of a gas flow, and a specific route of the gas pipeline.

In some embodiments, the government gas supervision and management platform may obtain, from a database of the government supervision management platform 110, a record related to the target region when the gas pipeline is constructed, and determine data related to the distribution of the gas pipeline therein as the required gas pipeline distribution data.

The sub-regions refer to a plurality of regions obtained by dividing the target region. In some embodiments, the government gas supervision and management platform may determine the plurality of sub-regions in various ways. For example, the government gas supervision and management platform may grid a map of the target region, divide the map of the target region into a plurality of grid regions based on a grid size and a grid shape, and determine the obtained grid regions as the required sub-regions. The grid size and the grid shape may be preset based on prior experience.

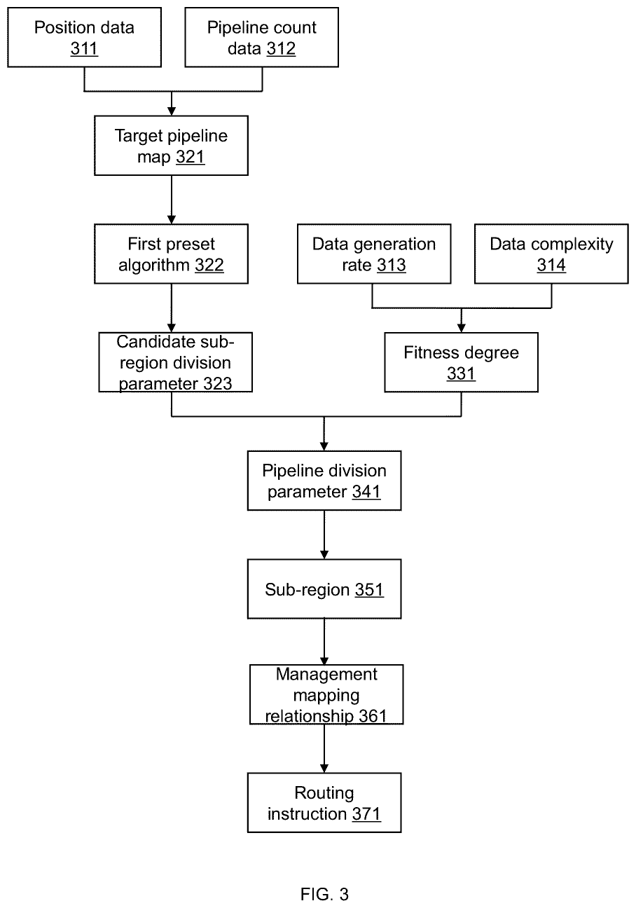

In some embodiments, the government gas supervision and management platform may also divide the gas pipeline to obtain the plurality of sub-regions through a method of constructing a target pipeline map as well as a method of determining a fitness degree. For more contents about this, please refer to FIG. 3 and the related descriptions.

Step 220, obtaining gas sensor data of each point in the plurality of sub-regions on the gas pipeline in the target region from a plurality of gas company management platforms through a government gas supervision sensor network platform.

The gas sensor data refers to obtained gas-related monitoring data. In some embodiments, the gas sensor data may include gas temperature data, gas humidity, gas flow rate data, gas flow data, and pipeline pressure data.

In some embodiments, the government gas supervision and management platform may obtain the gas sensor data at each point in the plurality of sub-regions of the gas pipeline through a pipeline monitoring device.

The point refers to a specific position on the gas pipeline in a sub-region where the gas sensor data needs to be collected. In some embodiments, the government gas supervision and management platform may determine a position on the gas pipeline where the pipeline monitoring device is installed as the point.

Step 230, determining, based on the gas sensor data and pipeline data, an actual leakage point on the gas pipeline.

The pipeline data refers to pipeline-related monitoring data obtained from the gas pipeline in the target region. In some embodiments, the pipeline data may include information such as a material, a model, a length, a diameter, and a service life of the pipeline.

In some embodiments, the government gas supervision and management platform may obtain a log record when the gas pipeline is installed and constructed from the database, and extract the corresponding pipeline data therefrom.

The actual leakage point refers to a specific point where the gas leakage occurs on the gas pipeline from the target region at a current time point.

In some embodiments, the government gas supervision and management platform may construct a vector database based on historical data, and determine the corresponding actual leakage point based on a matching vector search. In some embodiments, the government gas supervision and management platform may construct a target feature vector based on the gas sensor data and the pipeline data. The target feature vector may be constructed by various manners. For example, the target feature vector may be constructed by manners such as One-Hot or Word2Vec.

The vector database may include a plurality of reference vectors and corresponding reference leakage points. Each reference vector may be constructed based on historical gas sensor data and historical pipeline data. The reference vectors may be constructed in a manner similar to the target feature vector. The reference leakage points may be constructed based on a historical actual leakage point in a historical gas leakage event corresponding to the reference vector.

In some embodiments, the government gas supervision and management platform may determine the actual leakage point based on a similarity between the target feature vector and the plurality of reference vectors in the vector database. For example, the reference vector whose similarity with the target feature vector satisfies a first preset condition may be taken as a target vector, and the reference leakage point corresponding to the target vector may be taken as a final actual leakage point. The first preset condition may be set according to the situation. For example, the first preset condition may be that the similarity is maximized, or the similarity is greater than a threshold. For another example, the first preset condition may be that a vector distance is minimized.

In some embodiments, the government gas supervision and management platform may directly determine a point on the pipeline as the actual leakage point. In some embodiments, the gas company management platform may also determine a point on the pipeline on its own as the actual leakage point and upload the actual leakage point to the government gas supervision and management platform. In some embodiments, the gas company management platform may also determine, together with the government gas supervision and management platform, the point on the pipeline as the actual leakage point.

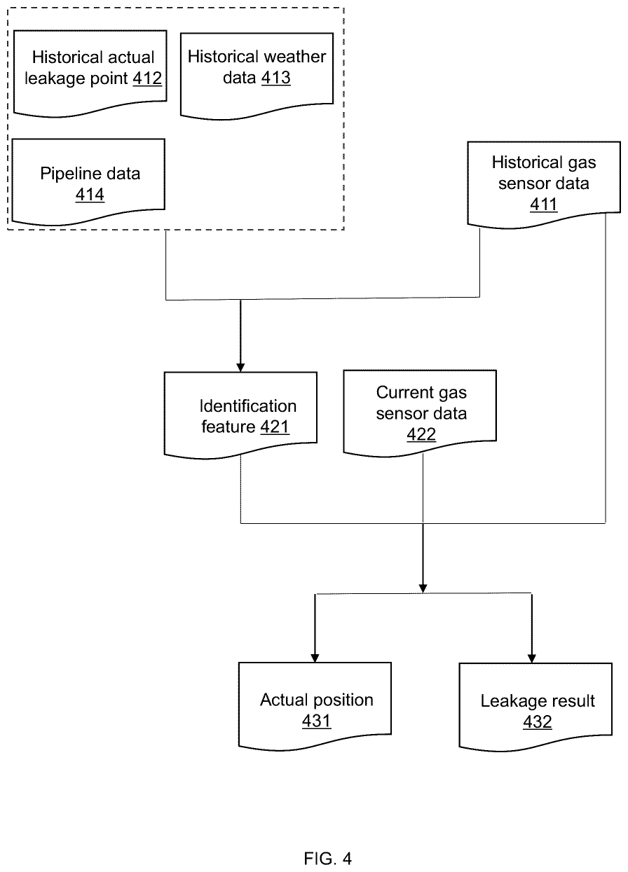

In some embodiments, the government gas supervision and management platform may also determine, based on an identification feature, current gas sensor data, and the historical gas sensor data, an actual position of the actual leakage point and a leakage result corresponding to each actual leakage point. For more contents on this section, please refer to FIG. 4 and the related descriptions.

Step 240, determining, based on the gas sensor data and a historical maintenance record, a potential hidden danger point on the gas pipeline.

The historical maintenance record refers to record information generated from inspections, repairs, and maintenance of the gas pipeline during a historical time period. In some embodiments, the historical maintenance record may at least include a historical maintenance time, a historical maintenance position, a historical failure cause, etc.

In some embodiments, the government gas supervision and management platform may obtain the record information generated during a historical time period when the gas pipeline was maintained, and extract the corresponding historical maintenance record from the record information.

The potential hidden danger point refers to a specific position on the gas pipeline in the target region where there is a risk of gas leakage.

In some embodiments, the government gas supervision and management platform may construct the vector database based on the historical data, and determine the corresponding potential hidden danger point based on the matching vector search. In some embodiments, the government gas supervision and management platform may construct the target feature vector based on the gas sensor data and the historical maintenance record. There may be various ways to construct the target feature vector. For example, the target feature vector may be constructed by manners such as One-Hot or Word2Vec.

The vector database may include a plurality of reference vectors and corresponding reference hidden danger points. Each reference vector may be constructed based on the historical gas sensor data and the historical maintenance record. The reference vector may be constructed in a manner similar to the target feature vector. The reference hidden danger points may be obtained based on historical leakage points corresponding to the reference vector before leakage.

In some embodiments, the government gas supervision and management platform may determine the potential hidden danger point based on the similarity between the target feature vector and a plurality of reference vectors in the vector database. For example, the reference vectors whose similarity with the target feature vector satisfies a preset condition may be taken as the target vector, and the reference hidden danger points corresponding to the target vector may be taken as the final potential hidden danger point. The preset condition may be set according to the situation. For example, the first preset condition may be that the similarity is maximized, or the similarity is greater than a threshold. For another example, the first preset condition may be that the vector distance is minimized.

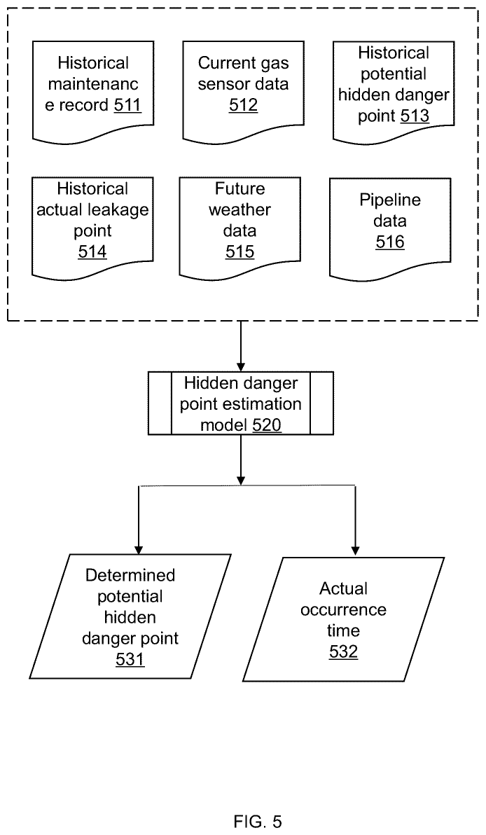

In some embodiments, the government gas supervision and management platform may also determine updated potential hidden danger point based on a hidden danger point estimation model. For details on this section, please refer to FIG. 5 and the related description.

Step 250, in response to an existence of the actual leakage point, generating, based on an actual position of the actual leakage point on the gas pipeline, a first maintenance instruction and a first adjustment instruction; sending the first maintenance to the gas company management platform corresponding to the actual position to instruct the gas company management platform to dispatch maintenance personnel to repair the actual position; and sending the first adjustment instruction to a gas pipeline control device corresponding to the actual position to adjust a working parameter of the gas pipeline control device.

The first maintenance instruction refers to an operational instruction used to instruct the gas company to repair the actual leakage point on the gas pipeline.

In some embodiments, the government gas supervision and management platform may establish a first preset table based on the actual position of the historical leakage point and leakage severity. The first preset table may include a correspondence between a historical actual position, a historical leakage severity, and different historical first maintenance instructions. By checking the first preset table, the government gas supervision and management platform may determine a current first maintenance instruction based on a current actual position and the leakage severity of the actual leakage point. The leakage severity may reflect a severity of the gas leakage, and the leakage severity may be positively correlated to a rate of the gas leakage.

The first adjustment instruction refers to an instruction used to instruct the gas company to regulate the gas pipeline control device within the gas pipeline where the actual leakage point exists. The working parameter refers to a control parameter for an operation of the gas pipeline control device (e.g., a gas pressure valve, a gas flow rate valve, etc.), and in some embodiments, the working parameter may at least include a gas pressure, etc.

In some embodiments, the government gas supervision and management platform may establish a second preset table based on the historical actual position and a historical working parameter. The second preset table may include a correspondence between the historical actual position, the historical working parameter, and different historical first adjustment instructions. The government gas supervision and management platform may determine a current first adjustment instruction based on the current actual position of the actual leakage point and the working parameter by checking the second preset table.

In some embodiments, when the government gas supervision and management platform generates the first maintenance instruction and the first adjustment instruction, the government gas supervision and management platform may send the first maintenance instruction to the gas company management platform corresponding to the actual position, and dispatch a preset count of maintenance personnel with corresponding maintenance tools to the actual position and perform maintenance according to a requested maintenance operation process. The gas device object platform 150 may receive the first adjustment instruction and adjust the gas pipeline control device corresponding to the actual position to reduce a pressure of the pipeline at the actual leakage point, and alleviate the leakage of gas.

Step 260, in response to an existence of the potential hidden danger point, generating, based on a potential position of the potential hidden danger point on the gas pipeline, a second maintenance instruction and a second adjustment instruction; and sending the second maintenance instruction to the gas company management platform corresponding to the potential position to instruct the gas company management platform to dispatch the maintenance personnel to check the potential position; and sending the second adjustment instruction to a gas pipeline monitoring device corresponding to the potential position to adjust a monitoring parameter of the gas pipeline monitoring device.

The second maintenance instruction refers to an operational instruction for instructing the gas company to inspect and maintain the potential hidden danger point on the gas pipeline. In some embodiments, the second maintenance instruction may include a position of the pipeline to be repaired, a required repair tool, a specific repair operation, and a count of repair personnel. A formation of the second maintenance instruction may be similar to the first maintenance instruction, which is referred to in the relevant content of the first maintenance instruction above.

In some embodiments, the government gas supervision and management platform may establish a third preset table based on a historical potential position and the historical working parameter. The third preset table may include a correspondence between the historical potential position, the historical working parameter, and different historical second maintenance instructions. The government gas supervision and management platform may determine a current second maintenance instruction based on a current potential position of the actual leakage point and the working parameter by checking the third preset table.

The second adjustment instruction refers to an instruction to regulate the gas pipeline monitoring device that has a potential hidden danger point within the gas pipeline.

In some embodiments, the second adjustment instruction may include a specific position of the gas pipeline monitoring device to be adjusted, a monitoring parameter to be adjusted, and an adjustment magnitude of the monitoring parameter. In some embodiments, the monitoring parameter may at least include a gas monitoring frequency and a monitoring accuracy. A formation of the second adjustment instruction may be similar to the first adjustment instruction, which is referred to in the relevant content of the first maintenance instruction above.

In some embodiments, the government gas supervision and management platform may establish a fourth preset table based on the historical potential position and a historical monitoring parameter. The fourth preset table may include a correspondence between the historical potential position, the historical monitoring parameter, and different historical second adjustment instructions. The government gas supervision and management platform may determine a current second adjustment instruction based on the current potential position of the actual leakage point and the monitoring parameter by checking the fourth preset table.

In some embodiments, when the government gas supervision and management platform generates the second maintenance instruction and the second adjustment instruction, the second maintenance instruction may be sent to the gas company management platform corresponding to the actual position, and the gas company management platform may dispatch a preset count of maintenance personnel to the potential position with the corresponding maintenance tools and perform a risk determination and maintenance according to the requested maintenance operation process. The gas device object platform 150 may receive the second adjustment instruction and adjust the gas pipeline monitoring device corresponding to the actual position and monitor the pipeline position with the potential risk of leakage more frequently.

In some embodiments of the present disclosure, by determining the actual leakage point and the potential hidden danger point, dispatching personnel to repair the actual leakage point, and reducing the gas pressure of the leakage point pipeline at the same time, the gas leakage may be reduced in a timely manner, thereby reducing a safety risk caused by the gas leakage. By dispatching personnel to inspect the potential hidden danger point and increasing the monitoring frequency of relevant monitoring devices, the potential hidden danger point may be repaired in a timely manner and fully monitored, thereby avoiding the gas leakage.

FIG. 3 is a schematic diagram illustrating an exemplary process for determining sub-regions and a management mapping relationship according to some embodiments of the present disclosure. Steps 310 to 360 (not shown in FIG. 3) may be performed by a government gas supervision and management platform.

Step 310, constructing a target pipeline map 321 based on position data 311 and pipeline count data 312 of a gas pipeline in a target region.

The position data 311 refers to information related to a geographic position of a distribution of the gas pipeline. In some embodiments, the position data may include coordinates and depths, etc. of the gas pipeline.

In some embodiments, the government gas supervision and management platform may obtain a log record from a database when the gas pipeline is installed and constructed, and extract corresponding position data therefrom.

The pipeline count data 312 refers to a use of counting to identify, differentiate, and manage the data of the gas pipeline, and the position of a current pipeline in the whole pipeline may be obtained through the pipeline count data corresponding to the gas pipeline.

In some embodiments, the government gas supervision and management platform may count the pipeline using a pipeline counting method to obtain the pipeline count data 312. As there are one or more gas pipelines, each of which is formed by connecting a plurality of gas sub-pipelines, all the gas pipelines may be counted using a same pipeline counting manner, or each of the gas pipelines may be counted using a separate pipeline counting manner. Exemplarily, there may be two pipelines, each including 20 sub-pipelines, and when counting all of the gas pipelines using the same pipeline counting manner, the sub-pipelines in a first pipeline count may be counted as 01 to 20, and the sub-pipelines in a second pipeline counting may be counted as 21 to 40. When each gas pipeline is counted using a separate pipeline counting manner, the sub-pipelines in the first pipeline counting may be counted as L1-01 to L1-20, and the sub-pipelines in the second pipeline count as L2-01 to L2-20. The L1 and L2 respectively refers to the first pipeline and the second pipeline.

The target pipeline map 321 refers to a knowledge map that represents a structure of the gas pipeline. The target pipeline map may indicate the position distribution of the gas pipeline.

The target pipeline map 321 may include at least one node as well as at least one edge, and in some embodiments, the node may correspond to a connection point between sub-pipelines of the gas pipeline. When two sub-pipelines are connected, the connection point may be determined as a node.

In some embodiments, the edge may correspond to the sub-pipeline of the gas pipeline, and a feature of the edge may include a data generation rate, a data complexity, a count, and a position corresponding to the sub-pipeline. A length of the edge in the target pipeline map may reflect an actual length of the sub-pipeline. The edge may be either undirected or directed. When the edge is a directed edge, the direction may be a direction of a gas flow.

The data generation rate 313 refers to a rate at which the gas pipeline monitoring device generates monitoring data when monitoring a segment of sub-pipeline. In some embodiments, the data generation rate may be positively correlated to the count of gas pipeline monitoring devices in the sub-pipeline and a frequency of detection. In some embodiments, the government gas supervision and management platform may obtain the data generation rate of the sub-pipeline over a historical time period and obtain an average value of the historical data generation rate by calculation. The average value of the historical data generation rate may be determined as the data generation rate of the sub-pipeline.

The data complexity 314 refers to a complexity of the monitoring data generated when monitoring the sub-pipeline, and the data complexity may be used to measure an amount of resources consumed by the government gas supervision and management platform in processing monitoring-related data. In some embodiments, the data complexity may be positively correlated to a magnitude of fluctuation and an accuracy of the monitoring data. Exemplarily, the greater the magnitude of fluctuation and the higher the accuracy of the monitoring data, the more resources the government gas supervision and management platform consumes in processing the monitoring-related data, and the higher the data complexity. In some embodiments, the government gas supervision and management platform may obtain the monitoring data generated by the sub-pipeline during the historical time period and the corresponding historical data complexity, and obtain the average value of the historical data complexity by calculation. The average value of the historical data complexity may be determined as the data complexity of the sub-pipeline.

Step 320, generating, based on the target pipeline map 321, a candidate sub-region division parameter using a first preset algorithm.

The first preset algorithm 322 refers to an algorithm that generates the candidate sub-region division parameter. In some embodiments, the first preset algorithm may be as follows: randomly assigning the sub-pipelines corresponding to the nodes to groups, and generating N of candidate sub-region division parameters. In some embodiments, the first preset algorithm may also be as follows: obtaining a count of sub-regions by gridding a position region where the gas pipeline is located according to a preset parameter, and dividing the sub-pipelines within the same sub-region into the same group. The preset parameter may include a shape, a size, and coordinates of a grid center point of a grid. By changing the preset parameter for N times, N of different candidate sub-region division parameters may be obtained.

The candidate sub-region division parameter 323 refers to one or more alternative sub-region division parameters. In some embodiments, the candidate sub-region division parameter may correspond to a plurality of groups of gas pipelines corresponding to the edges of the target pipeline map. For example, the candidate sub-region division parameter may include [S1(03,06,08,11), S2(01,05), S3(02,09,16), S4(07,10,12)] indicating the lengths of each pipeline branch included in each of the candidate sub-regions, for example, the lengths of the four pipeline segments included in the candidate sub-region S1 are 03, 06, 08, and 11, respectively. The greater a value of the pipeline branch length, the longer the pipeline.

Step 330, determining the data generation rate 313 and the data complexity 314 of the plurality of groups, and determining, based on the data generation rate 313 and the data complexity 314, a fitness degree 331 of the candidate sub-region division parameter corresponding to each of the plurality of groups.

In some embodiments, the government gas supervision and management platform 110 may divide the gas pipeline based on the candidate sub-region division parameter, obtain a plurality of groups corresponding to each candidate sub-region division parameter, and each group may correspond to a sub-region in the candidate sub-region division parameter. For more about the data generation rate 313 and the data complexity 314, please refer to descriptions above.

The fitness degree 331 may reflect a degree of reasonableness in the division of the candidate sub-regions. In some embodiments, the fitness degree may be expressed by a numerical value or a rating. Exemplarily, the smaller the numerical value of the fitness degree, the more reasonable a way in which the different regions are distributed.

In some embodiments, in order to ensure that the data generation rate and the data complexity of each sub-region are as balanced as much as possible, the government gas supervision and management platform may set a fitness degree function to be a sum of variance of the data generation rate of each sub-region and a variance of the data complexity. The data generation rate and the data complexity may be obtained as described above.

Step 340, determining, based on the candidate sub-region division parameter 323 and the corresponding fitness degree 331, a selected pipeline division parameter 341.

The pipeline division parameter 341 refers to a group of division parameters selected from the candidate sub-region division parameter. In some embodiments, the government gas supervision and management platform may select the candidate sub-region division parameter with the highest fitness degree from a plurality of candidate sub-region division parameters to determine a desired pipeline division parameter.

In some embodiments, the government gas supervision and management platform may determine the pipeline division parameter 341 in various ways. Exemplarily, the government gas supervision and management platform may randomly assign sub-pipeline corresponding to the node to the group, generate N of candidate sub-region division parameters. The government gas supervision and management platform may separately calculate average distances between all sub-pipelines and the corresponding management company for each of the candidate sub-region division parameters. The government gas supervision and management platform may further sort the N of candidate sub-region division parameters from smallest to greatest according to the average distance, and select the candidate sub-region division parameter with the shortest average distance as the desired pipeline division parameter.

Step 350, obtaining the plurality of sub-regions 351 by dividing the gas pipeline based on the selected pipeline division parameter 341.

An exemplary preset algorithm process is provided below to explain a specific implementation of determining the selected pipeline division parameter 341 in steps 320-350 in detail. In some embodiments, the preset algorithm process may be performed by the aforementioned government gas supervision and management platform. The preset algorithm process may include the following steps.

Step 1, coding the sub-pipelines of a gas pipeline based on their counting data, and determining the count of groups.

In some embodiments, the encoding manner may include, but not limited to, a binary encoding, a real count encoding; an upper limit of the count of groups may be preset based on a priori experience.

Step 2, based on the encoding of Step 1, generating N of candidate sub-region division parameters, i.e., N of initial solutions (parents).

In some embodiments, the government gas supervision and management platform may generate N of candidate sub-region division parameters by the first preset algorithm. For more contents on the first preset algorithm, please refer to the above descriptions.

Step 3, determining the fitness degree of each candidate sub-region division parameter by setting the fitness degree function. For more contents on setting the fitness degree function, please refer to the above descriptions.

Step 4, selecting the best fitness degree based on the selection function.

In some embodiments, the government gas supervision and management platform may determine a selection function based on, for example, a roulette selection method. A selection probability of the candidate sub-region division parameter may be negatively correlated to the fitness degree. For example, the smaller the fitness degree, the greater the selection probability of the candidate sub-region division parameter.

Exemplarily, the selection probability of the candidate sub-region division parameter may be 1−[fitness degree/total fitness degree value of a particular candidate sub-region division parameter]. The total fitness degree value may be a sum of the fitness degree of all the candidate sub-region division parameters.

Step 5, performing a crossover operation based on the candidate sub-region division parameter of the parent to generate a child.

The crossover operation refers to a process in which two individuals are taken as the parents for exchange and combination to generate the child with a mixture of features from both parents. In some embodiments, the government gas supervision and management platform may select, from a plurality of candidate sub-region division parameter, two candidate sub-region division parameters to perform the crossover operation, and generate a new candidate sub-region division parameter to be taken as the child. A crossover probability refers to a probability that two individuals undergo the crossover.

In some embodiments, the crossover probability may be preset based on the prior experience. Exemplarily, the crossover probability may be set to (0.4 to 0.99). In some embodiments, the crossover probability may also be positively correlated to the count of sub-pipelines, with a higher count resulting in a higher crossover probability.

In some embodiments, a type of crossover may also include one or more of a single-point crossover, a multi-point crossover, a uniform crossover, etc. The single-point crossover refers to a type in which the candidate sub-region division parameters exchange a plurality of data at a single crossover point. The multi-point crossover refers to a type in which the candidate sub-region division parameters exchange data at multiple crossover points. The uniform crossover refers to a process of scanning each data (e.g., the lengths of the sub-pipelines) in the candidate sub-region division parameters in turn, and determining whether the data is to be crossed with the data of another candidate sub-region division parameter based on the crossover probability.

Merely as an example, the parent candidate sub-region division parameter may include parameter A: [S1(03,06,08,11), S2(01,05), S3(02,09,16), S4(07,10,12)] and parameter B: [S1(02,04,07), S2(06,11), S3(03,19,16), S4(28,10,12)]. The government gas supervision and management platform may exchange 01 in S2 of the parameter A with 06 in S2 of the parameter B according to the single-point crossover to obtain parameter C: [S1(03,06,08,11), S2(06,05), S3(02,09,16), S4(07,10,12)] and parameter D: [S1(02,04,07), S2(01,11), S3(03,19,16), S4(28,10,12)].

Step 6, performing a mutation operation on the parent candidate sub-region division parameter to generate the child.

The mutation operation refers to changing the data of the child. In some embodiments, the government gas supervision and management platform may perform the mutation operation on the candidate sub-region division parameter of the parent based on a mutation probability, change the data of the candidate sub-region division parameter, and generate a new child candidate sub-region division parameter. The mutation probability may be 0.05. In some embodiments, a type of mutation may also include one or more crossover manners such as a basic positional mutation, a uniform mutation, a non-uniform mutation, etc.

The basic positional mutation refers to that the candidate sub-region division parameter is mutated based on a mutation probability for data at one or more randomly specified positions. The uniform mutation refers to replacing each of the data in the candidate sub-region division parameter based on the mutation probability using uniformly distributed random counts within a preset range. The non-uniform mutation refers to making a random perturbation to the data of the candidate sub-region division parameter, and using a result of the perturbation as the data after mutation.

Merely as an example, the parent candidate sub-region division parameter may include the parameter A: [S1(03,06,08,11), S2(01,05), S3(02,09,16), S4(07,10,12),], and the government gas supervision and management platform may mutate 02 in S3 of parameter A according to the basic positional mutation to obtain a random value 21 and parameter E [S1(03,06,08,11), S2(01,05), S3(21,09,16), S4(07,10,12),].

Step 7, selecting the child obtained from steps 5 and 6.

In some embodiments, the government gas supervision and management platform may select the candidate sub-region division parameter that satisfies a reservation condition. The reservation condition refers to a determination condition used to eliminate unreasonable candidate sub-region division parameter. To ensure that the pipelines in the sub-regions obtained by division of the candidate sub-region division parameter are connected as much as possible, and that no pipelines particularly far apart from each other are divided in one sub-region, it is necessary to use the reservation condition for screening.

In some embodiments, the reservation condition may include: in the pipeline feature map corresponding to the candidate sub-region division parameter, a count of nodes−a count of edges≤1, and a maximum positional distance between the sub-pipelines is in a preset distance range.

When the count of nodes−the count of edges>1, it indicates that there are at least two points in the current sub-region that are not connected with the edges, and the condition that the sub-pipelines in the sub-region are connected as much as possible is not satisfied. Considering that the sub-pipelines that are close to each other also has a certain mutual effect, it may also be necessary to consider whether the maximum positional distances between the sub-pipelines are in the preset distance range.

When the maximum positional distance between the sub-pipelines is less than a lower limit of the preset distance range, or greater than the upper limit of the preset distance range, the division of the sub-regions may be unreasonable. By limiting the maximum positional distance to lie within the preset distance range, it may be possible to ensure that a region range of the generated sub-regions is not too great or too small. In some embodiments, the preset distance range may be determined correlative to an average evaluation score of each gas company. For more contents on this section, please refer to FIG. 4 and the related descriptions.

Step 8, replacing the undesirable candidate sub-region division parameter (parents) with the candidate sub-region division parameter (child) that satisfies a condition.

In some embodiments, the government gas supervision and management platform may utilize newly generated candidate sub-region division parameter (e.g., the candidate sub-region division parameter of the child generated in steps 5 and 6) to replace the undesirable candidate sub-region division parameter (e.g., the candidate sub-region division parameter of the parents generated in steps 1 and 2) in an original population with greater fitness degree.

For example, the government gas supervision and management platform may sort the candidate sub-region division parameter (the parents) and the newly generated candidate sub-region division parameter (child) in the original population according to the fitness degree from the greatest to the smallest, and select a preset count of candidate sub-region division parameters in the newly generated candidate sub-region division parameters (child) with lower fitness degrees (i.e., smaller fitness degrees), and replace the preset count of the original candidate sub-region division parameters (parents) with the higher fitness degrees (i.e., greater fitness degrees). The preset count may be set based on prior experience.

Step 9, repeating the above steps 3 to 8, and repeatedly performing the evolution until an iteration stop condition is satisfied.

In some embodiments, the iteration stop condition may include that the maximum count of evolutions has been completed, that the fitness degree reaches a preset expectation, that the fitness degree stays the same for a preset count of iterations, or that a difference in fitness degree between two iterations is lower than a preset difference threshold. The count of evolutions, the preset expectation, the preset count of iterations, and the preset difference threshold may be set based on a variety of ways such as manual experience, network query, etc.

In some embodiments, the government gas supervision and management platform may select, after the iteration stops, the candidate sub-region division parameter with the smallest fitness degree as a target pipeline division parameter, the government gas supervision and management platform may further determine the count of groups corresponding to the candidate sub-region division parameter with the smallest fitness degree as the count of groups in the target pipeline division parameter, and divide each group according to the count of the corresponding gas sub-pipeline.

Step 360, determining a management mapping relationship 361 between the plurality of sub-regions 351 and the management company; and generating a routing instruction based on the management mapping relationship 361 and sending the routing instruction 371 to a gas data forwarding device of the gas pipeline network to create a corresponding route.

The management mapping relationship 361 refers to a correspondence between different sub-regions and the management company that manages the sub-region. To supervise the gas pipeline in the sub-region, data collected by the gas pipeline monitoring device in the sub-region may need to be sent to the corresponding management company through the corresponding route. The management company refers to a company that carries out maintenance and management of the gas pipeline, and the route refers to a control rule used to control how to transmit the monitoring data, the corresponding route may be created by the routing instruction, and the gas data forwarding device of the gas pipeline network may forward the received monitoring data to the gas company management platform corresponding to the management company, and may forward the received monitoring data of the sub-region to the gas company management platform corresponding to the corresponding management company.

The gas data forwarding device refers to a forwarding device that forwards the monitoring data collected by the gas pipeline monitoring device to a corresponding platform. In some embodiments, the gas data forwarding device may include, but not limited to, a router, a server, etc.

The routing instruction 371 refers to an instruction used to create routes. In some embodiments, the routing instruction may be: controlling, based on the management mapping relationship, the gas data forwarding device to forward the monitoring data of the corresponding sub-region to the corresponding gas company management platform of the management company.

The government gas supervision and management platform may determine the management mapping relationship 361 in various ways. In some embodiments, the government gas supervision and management platform may determine the distances between the sub-region and all the gas companies in the vicinity of the sub-region, and select the management company with the shortest distance among them, to be determined as the management company corresponding to the sub-region. After determining all the management companies corresponding to the sub-region, the management mapping relationship may be obtained.

In some embodiments, the government gas supervision and management platform may also determine a candidate management company corresponding to each of the plurality of sub-regions; and from the candidate management companies, determine, based on the evaluation scores of the candidate management companies, and importance degrees of the sub-regions, the management company corresponding to each sub-region.

The candidate management company refers to a company that manages the sub-region. In some embodiments, the government gas supervision and management platform may calculate a composite index of the company based on the evaluation scores of candidate management companies and the importance degrees of the sub-regions, and select the candidate management company with the highest composite index to be the corresponding management company.

The evaluation score may reflect the management ability of the management company to manage the gas pipeline. In some embodiments, the evaluation score may be negatively correlated to a gas failure rate within the sub-region. For a more detailed description of the evaluation score, please refer to the descriptions in FIG. 5.

Exemplarily, the composite index of the management company may be calculated by equation (1):

$$U = {k}_{1} \times D + {k}_{2} \times Y \qquad ( 1 )$$

where U denotes the composite index of the management company, k₁ and k₂ are coefficients, D denotes an actual distance from the management company to the sub-region, and Y denotes the evaluation score of the management company. The coefficients k₁ and k₂ may be preset based on prior experience.

The importance degree may reflect a degree to which the sub-region needs to be focused on. In some embodiments, the importance degree may be positively correlated to a total count of sub-pipelines within the sub-region. Exemplarily, the higher the count of sub-pipelines within the sub-region, the more likely the sub-region is to be abnormal, the more focus is required, and the higher the corresponding importance degree.

In some embodiments, the government gas supervision and management platform may determine the corresponding importance degree of the sub-region based on the constructed pipeline connection map. The pipeline connection map may be a drawing that reflects a connection relationship between the pipeline and a user.

In some embodiments, the pipeline connection map may be composed of at least one node and at least one edge, and the node may include a pipeline node and a user node. The pipeline node may correspond to a bifurcation point of a gas pipeline. When a gas pipeline needs to be bifurcated or connected, a connecting junction may be determined as the pipeline node. The user node may be a node with a non-zero in-degree and a zero out-degree, and the user node may correspond to a gas user.

In some embodiments, the edge may correspond to the gas pipeline. The edge may be a directed edge, and a direction may be the direction of the gas flow.

In some embodiments, the importance degree of the pipeline may be positively correlated to an average of neighbor degrees of the pipeline node corresponding to the pipeline and all the user nodes as well as a user path count. The neighbor degree of the pipeline node to the user node refers to a count of nodes passed on a shortest path from the corresponding node of the pipeline to the user node (the user nodes is counted as a passed node). The user path count refers to a count of user nodes that are accessible to the pipeline node along the direction of the gas flow. Exemplarily, in a path of pipeline node A pipeline node B-user node C, the neighbor degree of the pipeline node A and the user node C is 2, and the user path count of pipeline node A is 1.

Exemplarily, the importance degree of the pipeline may be calculated by equation (2):

$$M = {k}_{1} \times \frac{{L}_{1} + {L}_{2} + ... + {L}_{n}}{N} + {k}_{2} \times P \qquad ( 2 )$$

where M denotes the importance degree of the pipeline, k₁ and k₂ are coefficients, Lₙ denotes the neighbor degree of the pipeline node to a user node n, N denotes a total count of all the pipeline nodes that are accessible to the user node, and P denotes the count of user paths. The coefficients k₁ and k₂ may be preset based on prior experience, and k₂>k₁.

In some embodiments, a statistical value (e.g., a mean, a maximum value, a median value, etc.) of the importance degree of the pipeline in the sub-region may be determined as the corresponding importance degree of the sub-region.

In some embodiments, the government gas supervision and management platform may determine the management company corresponding to the sub-region according to the following steps.

Step A, according to a determination manner, the candidate management company corresponding to the sub-region may be determined and sorted in an ascending order according to the composite index. Further, all the sub-regions that the candidate management company manages may be determined, and the sub-regions may be sorted from highest to lowest according to the importance degree corresponding to the sub-regions. The determination manner may include the sub-regions being located at a distance from the gas company that is less than a preset distance threshold.

Step B, the company with the highest ranked composite index among the candidate management companies corresponding to the sub-region may be selected as the candidate management company for the sub-region. It may be determined Whether the rank of the importance degree of the sub-region exceeds the maximum management threshold of the management company, in response to the rank of the importance degree of the sub-region not exceeding the maximum management threshold of the management company, then skip to step C-1; in response to the rank of the importance degree of the sub-region exceeding the maximum management threshold of the management company, skip to step C-2.

Step C-1, the candidate management company may be determined as the management company of this sub-region, and the process may be completed.

Step C-2, the candidate management company may be removed from the candidate management companies corresponding to the sub-region, and skip to step B.

The above step B and step C-2 may be repeated until the step C-1 is satisfied.

In some embodiments of the present disclosure, by determining the composite index of the candidate management companies, ranking the candidate management companies, and then ranking the sub-regions that the candidate management companies manage according to the importance degree, it may be possible to ensure that the more important sub-regions are assigned to more experienced management companies and the less important sub-regions are assigned to a management company with an average management ability, thereby reducing a pipeline failure rate.

In some embodiments, in response to that a replacement condition is satisfied, the government gas supervision and management platform may re-determine the management company corresponding to the sub-region.

The replacement condition refers to a determination condition for changing the management company corresponding to the sub-region. In some embodiments, the replacement condition may be that under the management of the management company, a frequency of abnormal situations occurring in the sub-region is higher than a preset threshold.

The abnormal situation refers to a situation where there is an abnormality in the gas pipeline. In some embodiments, the abnormal situation may include a gas leakage, a gas pipeline failure, a false alarm, a misdiagnosis, etc.

In some embodiments, when the replacement condition is satisfied, the government gas supervision and management platform may remove, based on the above step C-2, the company from the candidate management company corresponding to the sub-region and skip to step B, and further re-select the company with the highest ranked composite index as the management company for the sub-region.

In some embodiments of the present disclosure, when failures or misjudgments repeatedly occur in a sub-region under the jurisdiction of the management company, it indicates that the current management company does not have the management ability over the sub-region. At this point, it may be considered to update the management mapping relationship and replace the management company that manages the sub-region, thereby ensuring adequate supervision of the sub-region.

In some embodiments of the present disclosure, by using the target pipeline map to analyze and process, for example, the sub-pipeline of the gas pipeline, it may be possible to efficiently uncover potential associations between different information in messy and complex data.

FIG. 4 is a schematic diagram illustrating an exemplary process for determining the actual leakage point according to some embodiments of the present disclosure.

As shown in FIG. 4, determining the actual leakage point on a gas pipeline may include determining an identification feature 421 based on historical gas sensor data 411, a historical actual leakage point 412, historical weather data 413, and pipeline data 414 of each point in the plurality of sub-regions.

The historical gas sensor data 411 refers to gas sensor data generated during a historical time. For more contents about gas sensor data, please refer to related descriptions in FIG. 2.

The historical weather data 413 refers to weather-related data generated over a historical time period. In some embodiments, the historical weather data 413 may include at least one of temperature data, precipitation data, and humidity data.

In some embodiments, a government gas supervision and management platform may establish a database, store the historical weather data 413 in the database, and read the historical weather data 413 from the database.

For more contents on the pipeline data 414, please refer to the related descriptions in FIG. 2.

The identification feature 421 refers to a feature to be recognized, which is distinct from each other. In some embodiments, the identification feature 421 may include different kinds of data. For example, the identification feature 421 may include at least one of a flow rate, a pressure, and a temperature. Identification feature data corresponding to the identification feature 421 may include at least one of flow rate data, pressure data, temperature data, etc.

In some embodiments, the government gas supervision and management platform may determine the identification feature 421 in various manners. For example, the government gas supervision and management platform may determine the identification feature 421 through a feature extraction and/or a feature selection.

The feature extraction and/or the feature selection refers to extracting the desired data and removing redundant data from the plurality of data.

In some embodiments, the feature extraction may include at least one of a principal component analysis (PCA), a linear discriminant analysis (LDA), a singular value decomposition (SVD), etc. The feature selection may include at least one of an information gain, a relief algorithm, a chi squares algorithm, etc.

In some embodiments, the government gas supervision and management platform may determine the identification feature 421 using the feature selection based on a cluster analysis algorithm. In some embodiments, the feature selection based on the cluster analysis algorithm may include the following steps.

Step S1: selecting at least a feature subset from original features.

The original feature refers to a collection of data formed by data generated over a plurality of historical times. In some embodiments, the original feature may include at least one of the historical gas sensor data 411, the historical weather data 413, the pipeline data 414, etc. In some embodiments, the government gas supervision and management platform may determine the original features in various manners, for example, at least one of reading from historical data, obtaining a manual input, etc.

A feature subset refers to a collection formed by data selected from the original features. For example, the feature subset may include at least one of (historical gas sensor data, historical weather data), (historical gas sensor data, pipeline data), (historical weather data, pipeline data), etc.

In some embodiments, the government gas supervision and management platform may select at least one of the data from the original features to form the feature subset.

Step S2: performing a cluster analysis on the feature subset.

In some embodiments, the government gas supervision and management platform may use the clustering algorithm to cluster and analyze a selected feature subset. The clustering algorithm may include at least one of a K-means algorithm (K-means), a hierarchical clustering, etc. In some embodiments, the government gas supervision and management platform may cluster the data corresponding to each feature subset.

Step S3: evaluating the feature subset.

In some embodiments, the government gas supervision and management platform may perform a cluster score on a clustering effect of the feature subset through various manners. For example, the government gas supervision and management platform may compare a similarity between results of the clustering using the original features and the results of the clustering using the feature subset, the higher the similarity, the higher the clustering score.

The similarity may include at least one of a similarity in the count of clusters obtained by clustering and a similarity in elements included within each cluster, etc. For example, the original features may include 10 pieces of data, counted 1, 2, 3, . . . , 10, etc. For clustering using the original features, the original features may be divided into three clusters and the three clusters, namely (1, 2, 5, 7), (3, 9), (4, 6, 8, 10). The government gas supervision and management platform may compare the similarity between the result of clustering the feature subset and the three clusters separately.

Step S4: determining the identification feature.

In some embodiments, the government gas supervision and management platform may calculate, in various manners, a composite score; and determine, based on the composite score, the identification feature.

The composite score refers to a score that evaluates the feature subset. In some embodiments, the composite score may be positively correlated to the clustering score and negatively correlated to the count of features in the feature subset. When the clustering score is higher and the count of features in the feature subset is lower, the composite score may be higher.

In some embodiments, the government gas supervision and management platform may use a third preset algorithm to calculate the composite score. For example, the third preset algorithm may be that the composite score=a first coefficient×the clustering score−a second coefficient×the count of features in the feature subset. The first coefficient and the second coefficient may be preset values.

In some embodiments, as illustrated in FIG. 4, the government gas supervision and management platform may determine, based on the identification feature 421, current gas sensor data 422, and the historical gas sensor data 411, an actual position 431 of the actual leakage point and a leakage result 432 corresponding to each actual leakage point.

The actual position 431 refers to a position on the gas pipeline where the leakage actually occurs. In some embodiments, the actual position 431 may be characterized by at least one of coordinates, a latitude, a longitude, or a gas pipeline count.

The leakage result 432 refers to data characterizing whether the leakage occurs on the gas pipeline. In some embodiments, the leakage result 432 may include whether the leakage occurs and a leakage intensity.

The leakage intensity is a term that characterizes an extent to which a leakage actually occurs on the gas pipeline. In some embodiments, the leakage intensity may be expressed on a graded scale. For example, a primary leakage, a secondary leakage, and a tertiary leakage.

In some embodiments, the government gas supervision and management platform may determine the leakage intensity based on leakage data of the gas in the gas pipeline when the gas leaks from the actual position 431. The leakage data may include at least one of an air pressure, a flow rate, and a flow volume. For example, the government gas supervision and management platform may compare one of the leakage data with a corresponding preset leakage threshold. The preset leakage threshold may include a first leakage threshold, a second leakage threshold, and a third leakage threshold, in an increasing order. When at least one of the leakage data is greater than the first leakage threshold, greater than the second leakage threshold, and/or greater than the third leakage threshold, the government gas supervision and management platform may correspondingly determine that the leakage intensity is the primary leakage, the secondary leakage, and/or the tertiary leakage. In some embodiments, the government gas supervision and management platform may also consider a plurality of the leakage data in a comprehensive manner to obtain a comprehensive consideration result, and compare the comprehensive consideration result with the corresponding preset leakage threshold. The comprehensive consideration may include calculating the plurality of leakage data using a fourth preset algorithm. For example, calculating an average of the plurality of leakage data.

In some embodiments, the leakage data may be obtained via a sensor, for example, via at least one of a pressure sensor, a flow rate sensor, or a flow volume sensor. In some embodiments, the preset leakage threshold may be obtained based on at least one of experience, the historical data, or the manual input.

In some embodiments, the government gas supervision and management platform may determine, based on the identification feature 421, identification feature data corresponding to the identification feature 421. For example, when the identification feature 421 includes the flow rate and a pressure, the identification feature data may include the flow rate data and the pressure data.

In some embodiments, the government gas supervision and management platform may select, based on the identification feature data, from the current gas sensor data 422, the gas sensor data corresponding to the identification feature data, and construct, based on the selected gas sensor data, a leakage feature vector. For example, when the identification feature 421 includes the flow rate and the pressure. From the current gas sensor data 422, the current flow rate data and the pressure data may be selected, and a vector (x, y) may be constructed based on the flow rate data and the pressure data, where x denotes the flow rate data and y denotes the pressure data.

In some embodiments, the government gas supervision and management platform may construct a vector database based on the historical data. For example, the vector database may be constructed based on data such as the historical gas sensor data 411, the historical actual leakage point, and a historical leakage intensity. In some embodiments, the government gas supervision and management platform may match the vector database based on the leakage feature vector, select the historical leakage vector that has the highest similarity to the leakage feature vector in the vector database, and take a historical actual position and a historical leakage result corresponding to the historical leakage vector as the actual position and the leakage result corresponding to the leakage feature vector.

Some embodiments provided in the present disclosure, by determining the identification feature, a targeted selection of the collected data may be performed, which effectively reduces a data dimensionality, and reduce the data that needs to be analyzed when determining whether the leakage occurs. As a result, a calculation amount may be reduced, the calculation may be accelerated, a situation where redundant data interferes with a calculation process may be avoided, and an untimely determination causing untimely maintenance by subsequently dispatching personnel may be avoided.

The second preset algorithm refers to an algorithm that determines a correlation between a historical potential hidden danger point and the historical actual leakage point.

A strong association rule refers to an association rule that satisfies a support level condition and a confidence level condition. In some embodiments, the strong association rule may include (position 1, presence of the potential hidden danger point), (position 2, presence of the potential hidden danger point)→(position 3, a current actual leakage point). That is, if potential the hidden danger point exists in position 1 and position 2, it may be inferred that the actual leakage point exists in position 3.

In some embodiments, the support level condition may include that a support level is greater than or equal to a support level threshold. In some embodiments, the support level threshold may be obtained based on at least one of the experience, the historical data, the manual input, etc. In some embodiments, the confidence level condition may include that a confidence level is greater than or equal to a confidence level threshold. In some embodiments, the confidence level threshold may be obtained based on at least one of the experience, the historical data, and the manual input, etc.

The support level of the strong association rule is denoted in the algorithm as SA→B, and refers to a percentage of the data covering the association rule. In some embodiments, the support level may be calculated by equation (3) as:

$$S ( A \to B ) = S ( A ⋃ B ) = \begin{matrix}item set including A ⋃ B \\ total item set\end{matrix} \qquad ( 3 )$$

where itemset including A∪B refers to an amount of data for which both events A and B occur. For example, the amount of data for the occurrence of actual leakage point at position 3 when the potential hidden danger point occurs at position 1, the potential hidden danger point occurs at position 2. The total itemset denotes a total amount of data. For example, the total amount of data for the historically obtained potential hidden danger points, and the actual leakage points.

The confidence level of the strong association rule may be indicated in the algorithm as CA→B, and the confidence level may measure the degree of confidence of the strong association rule. In some embodiments, the confidence level may be by equation (4) as:

$$C ( A \to B ) = \frac{S ( A ⋃ B )}{S ( A )} \qquad ( 4 )$$

where S(A∪B) denotes the amount of data that both events A and B occur. S(A) denotes the amount of data that event A occurs. C(A→B) denotes a proportion of the amount of data that both events A and B occur in the amount of data that event A occurs.

In some embodiments, the support level threshold and the confidence level threshold may be correlated to a historical detection missed count frequency, a historical actual leakage frequency.

The historical detection missed count frequency refers to a frequency at which leakages actually occurred but are not detected over a historical time period. In some embodiments, the historical detection missed count frequency may be determined based on various manners. For example, the historical detection missed count frequency may be obtained based on at least one of the historical data, or obtained by checking a table, etc.

The historical actual leakage frequency refers to a frequency of leakages actually occurred over the historical time period. In some embodiments, the historical actual leakage frequency may be determined in various manners. For example, the historical actual leakage frequency may be obtained based on the historical data, or obtained by checking a table, etc.

In some embodiments, the support level threshold and the confidence level threshold may be negatively correlated to the historical detection missed count frequency and the historical actual leakage frequency.

By correlating the support level threshold and the confidence level threshold to the historical detection missed count frequency and the historical actual leakage frequency, it may be possible to improve the accuracy of the support level threshold and the confidence level threshold.

The actual leakage point to be updated refers to an actual leakage point that is obtained by calculation according to the strong association rule.

In some embodiments, the government gas supervision and management platform may construct a dataset table based on the historical potential hidden danger point and the historical actual leakage point.

The dataset table may include historical actual statuses corresponding to each point of the plurality of sub-regions on the gas pipeline in the target region. In some embodiments, the dataset table (1) may include:

| Time point | x₁ | x₂ | x₃ | x₄ |
|---|---|---|---|---|
| Time point 1 | −1 | 0 | 1 | −1 |
| Time point 2 | −1 | −1 | 1 | −1 |
| Time point 3 | 0 | 1 | −1 | −1 |
| Time point 4 | −1 | 0 | 1 | 1 |
| Time point 5 | −1 | −1 | 0 | 0 |

The time point denotes a time at which the gas sensor data is collected. The x₁, x₂, x₃, and x₄ denote the first position, the second position, the third position, and the fourth position, respectively. −1 denotes that the position is determined as the potential hidden danger point. 0 denotes that the position is normal. 1 denotes that the position is determined as the actual leakage point.

In some embodiments, the government gas supervision and management platform may determine the actual leakage point to be updated based on the strong association rule by means of the Apriori algorithm.

For example, the preset support level threshold and the confidence level threshold may be: 0.6, 0.7 respectively. The count of iteration step of the Apriori algorithm may be k, k=1, 2, 3 . . . n.

When k=1, at least one 1-item set may be generated, the 1-item sets with support levels less than the support level threshold may be eliminated, and the remaining 1-item set may be determined as a frequent 1-item set L1.

For example, according to Table (1), eight 1-item sets such as {(x₁, −1)}, {(x₁, 1)}, {(x₂, −1)}, {(x₂, 1)}, {(x₃, −1)}, {(x₃, 1)}, {(x₄, −1)}, {(x₄, 1)}, etc. may be generated. The support level for each of the 8 1-item sets may be calculated. For example, {(x₁, −1)} occurs in time points 1, 2, 4, and 5 out of 5 time points, so the corresponding support level may be 4/5=0.8. {(x₄, 1)} occurs only at time point 4 out of the 5 time points, and the corresponding support level may be 1/5=0.2. A case of abnormal position may not be concerned, therefore, 1-item sets such as {(x₁, 0)}, {(x₂, 0)}, {(x₃, 0)}, {(x₄, 0)}, etc. may not be generated.

In some embodiments, the government gas supervision and management platform may construct a 1-item set support table based on the 1-item set support level. In some embodiments, the 1-item set support table (2) may include:

| {(x₁, −1)} | {(x₁, 1} | {(x₂, −1)} | {(x₂, 1)} | {(x₃, −1)} | {(x₃, 1)} | {(x₄, −1)} | {(x₄, 1)} |
|---|---|---|---|---|---|---|---|
| 0.8 | 0 | 0.4 | 0.2 | 0.2 | 0.6 | 0.6 | 0.2 |

Only {(x₁, −1)}, {(x₃, 1)}, and {(x₄, −1)} have support levels greater than or equal to the support degree threshold, then the determined frequent 1-item set L1={(x₁, −1)}, {(x₃, 1)}, and {(x₄, −1)}. By determining the strong association rule, the potential hidden danger point that satisfies the requirements may be determined as the actual leakage point to be updated based on the strong association rule. The actual leakage point to be updated and the actual leakage point may be confirmed as the updated actual leakage points, so as to improve the accuracy of confirming the actual leakage points. When the maintenance personnel are dispatched to perform maintenances, they may be able to maintain the potential hidden danger points and reduce a risk of leaks occurring in the gas pipelines.

FIG. 5 is a schematic diagram illustrating a structure of a hidden danger point estimation model according to some embodiments of the present disclosure.

A hidden danger point estimation model 520 refers to a model used to determine a determined potential hidden danger point 531 at a future time point. The hidden danger point estimation model 520 may be a machine learning model, for example, a long short term memory recurrent neural network (LSTM), etc.

In some embodiments, an input to the hidden danger point estimation model 520 may include a historical maintenance record 511, current gas sensor data 512, a historical potential hidden danger point 513, a historical actual leakage point 514, future weather data 515, and an output may be a determined potential hidden danger point 531 and an actual occurrence time 532 for the future time point.

The historical maintenance record 511 refers to a record related to the maintenance of a gas pipeline during a historical time period. In some embodiments, a government gas supervision and management platform may obtain the historical maintenance record 511 in various manners, for example, from historical data. In some embodiments, the historical maintenance record 511 may include at least one of a maintenance time, a maintenance count, and a maintenance position.

The current gas sensor data 512 refers to gas sensor data generated during a current time period. The historical potential hidden danger point 513 refers to the potential hidden danger point determined during the historical time period. The historical actual leakage point 514 is an actual leakage point identified during the historical time period. For more contents on the gas sensor data, the potential hidden danger point, the actual leakage points, and pipeline data 516, please refer to the related descriptions in FIG. 2.

The future weather data 515 refers to weather-related data in the future time period. In some embodiments, the future weather data 515 may be similar to historical weather data. For more contents on the future weather data 515, please refer to the related descriptions of FIG. 4.

The actual occurrence time 532 refers to a time at which the potential hidden danger point is transformed into the actual leakage point.

The better the management company management ability, the lower a probability or a count of potential hidden danger points appear in the sub-region corresponding to the management company.

In some embodiments, an input to the hidden danger point estimation model 520 may also include an evaluation score of the management company corresponding to the sub-region.

The evaluation score refers to a score derived from evaluating the management ability of the management company, which characterizes the management ability of the management company. In some embodiments, the government gas supervision and management platform may determine the evaluation score based on the count of sub-region managed by the management company corresponding to the sub-region, a historical detection missed count frequency (a frequency of leakage misjudgment), an average instruction response rate, and an average failure frequency of the sub-region under management in various manners. In some embodiments, the evaluation score may be negatively correlated to the count of sub-regions, the historical detection missed count frequency, the average instruction response rate, and the average failure frequency.

In some embodiments, the government gas supervision and management platform may determine the evaluation score based on a preset algorithm. For example, evaluation score=100−(coefficient 1×Count of sub-regions managed+coefficient 2×historical detection missed count frequency+coefficient 3×average failure frequency of sub-regions managed+coefficient 4×average instruction response rate). The coefficient 1, the coefficient 2, the coefficient 3, and the coefficient 4 may be preset values, which are obtained based on at least one of experience, historical data, etc.

For more contents on the historical detection missed count frequency, please refer to the related descriptions in FIG. 5.

The instruction response rate refers to a time interval between a time when a government issues an instruction to the management company and a time when the management company begins to act. The average instruction response rate refers to the average of response rates of a plurality of instructions over a time period. In some embodiments, the government gas supervision and management platform may obtain the instruction response rate in various manners, for example, through at least one of the historical data or manual input.

The failure frequency refers to a frequency of failures of the gas pipeline. In some embodiments, the government gas supervision and management platform may determine the frequency of failures in various manners, for example, through at least one of the historical data or the manual input.

By taking the evaluation score as the input to the hidden danger point estimation model to determine the potential hidden danger points, the management ability of the management company may be considered, which is conducive to improving the accuracy of determining the potential hidden danger points.

In some embodiments, the method for obtaining the hidden danger point estimation model may include intensively training an initial hidden danger point estimation model based on a target training sample corresponding to the target region, and obtaining a trained hidden danger point estimation model.

In some embodiments, the hidden danger point estimation model may be obtained by training a plurality of labeled target training samples. The government gas supervision and management platform may input the plurality of target training samples with labels into the initial hidden danger point estimation model, construct a loss function from the labels and a result of the initial hidden danger point estimation model, and iteratively update a parameter of the initial hidden danger point estimation model based on the loss function. When the loss function of the initial hidden danger point estimation model satisfies a preset condition, the model training may be completed and the trained hidden danger point estimation model may be obtained. The preset condition may be that the loss function converges or a count of iterations reaches a threshold.

In some embodiments, when training the hidden danger point estimation model, a first hidden danger point estimation model may be obtained by training a plurality of initial training samples with labels. Then, based on target training sample data corresponding to the target region, a second intensive training may be performed on the first hidden danger point estimation model, and a second hidden danger point estimation model may be obtained as a final hidden danger point estimation model.

In this way, a basic accuracy of the first hidden danger point estimation model may be ensured. Considering the characteristics of different target regions, different environments of different target regions may lead to great differences in the training samples, second hidden danger point estimation model corresponding to different target regions may be trained according to characteristics of different target regions. In this way, an accuracy and a reliability of the finally obtained hidden danger point estimation model may be improved, which saves a training time, and saves an effort to re-train the first hidden danger point estimation model for each target region.

In some embodiments, the target training sample may include a sample historical maintenance record, sample gas sensor data, a sample historical potential hidden danger point, a sample historical actual leakage point, sample weather data, and sample pipeline data at a first moment. In some embodiments, the target training sample may be obtained based on the historical data of the target region.

In some embodiments, the labels of the target training sample may include the actual leakage point and an actual leakage time at a second moment. The second moment may be later than the first moment. In some embodiments, the target training sample may further include the evaluation score of the management company corresponding to the sub-region. For more contents about the evaluation score, please refer to the previous descriptions.

In some embodiments, to enhance an adaptability and a generalizability of the hidden danger point estimation model, the target training sample may include a plurality of training samples with a plurality of different actual occurrence times. By adopting a plurality of training samples at a plurality of different actual occurrence time for training the hidden danger point estimation model, the accuracy for the hidden danger point estimation model to predicting potential hidden danger points in different time periods may be improved.

In some embodiments, the government gas supervision and management platform may determine the target training sample based on a preset range.

The preset range refers to a proportion of the samples corresponding to the labels for a certain occurrence actual time period out of a total sample. In some embodiments, the government gas supervision and management platform may obtain the target training sample from the historical data of the target region. For example, the target training sample may be obtained in a time period from the moment of a sample data collection to a leakage at the point corresponding to that sample data may be referred to as the occurrence actual time period. The historical data over the time period may be divided into a plurality of segments according to a count of time segments with a preset range, thereby obtaining a plurality of training samples corresponding to a plurality of time segments. The count of time periods may be the count of segments after segmenting the time period. The plurality of time segments may be of the same or different lengths.

In some embodiments, the preset range may be calculated based on a fifth preset algorithm. The fifth preset algorithm may be, preset range=(100%/count of time segments). For example, starting at a certain moment, a sample of all labels in the historical data that corresponds to an actual occurrence time segment of two hours. The count of preset time segments may be 4, and each preset range may be 25%. That is, the historical data in each time segment may account for 25% of the historical data within two hours. The two hours may be segmented according to the preset range, in each of the four time segments 0-15 min, 15-30 min, 30-60 min, 60-120 min, the historical data of each time segment may account for 25%. The historical data within the four ranges of 0-15 min, 15-30 min, 30-60 min, and 60-120 min may be set as the training samples, and based on the actual occurrence times of 0-15 min, 15-30 min, 30-60 min, 60-120 min, etc., the labels may be set. In some embodiments, the length of each time segment may be the same or different. For example, starting at a certain moment, the historical data may be obtained for a two-hour range. The count of preset time segments may be 4. The historical data in the four time segments 0-30 min, 30-60 min, 60-90 min, and 90-120 min may be taken as the training samples.

In some embodiments, the government gas supervision and management platform may determine a count of training samples corresponding to each actual occurrence time in the target training sample based on a historical leakage frequency, gas company scale data, gas pipeline data, and bandwidth data of the target region.

In some embodiments, the government gas supervision and management platform may construct a training feature vector (x₀, y₀, z₀, t₀) based on the historical leakage frequency, the gas company scale data, the gas pipeline data, and the bandwidth data of the target region. In the vector database, the similarity between the training feature vector and a standard vector in the vector database may be compared, the standard vector with the highest similarity may be determined, and a count of training samples corresponding to the standard vectors with the highest similarity may be determined as the count of target training samples corresponding to each actual occurrence time. In some embodiments, the government gas supervision and management platform may determine the count of training samples corresponding to the standard vectors in various manners, for example, from the historical data, etc.

The gas company scale data refers to data related to the scale of the management company within the target region, for example, at least one of a count of management companies corresponding to the target region, a count of sub-regions managed by each management company, a count of employees (e.g., a count of maintenance personnel) of the management company, etc. In some embodiments, the gas company scale data may be obtained based on the historical data.

The gas pipeline data refers to data related to the gas pipeline, for example, at least one of a count of the gas pipelines, a size of a distribution region, an area, etc. In some embodiments, the gas pipeline data may be obtained based on the historical data.

The bandwidth data refers to data associated with a transmission network, for example, at least one of a data transmission rate, a transmission volume, etc. In some embodiments, the bandwidth data may be obtained from a vendor.

In the target region, if there are many management companies with great scales and great bandwidths, and the gas pipelines have a small count and a small distribution region, there may be smaller count of gas pipelines and smaller region under the management of each management company. As a result, a management pressure for the management company may be smaller, thereby reducing the count of training samples corresponding to the time period closer to the current time period, and improving the count of training samples corresponding to the time period farther from the current time period. On the contrary, the count of training samples corresponding to the time period closer to the current time period may be improved, and the count of training samples corresponding to the time period farther from the current time period may be reduced. By obtaining a plurality of training samples corresponding to a plurality of time periods, different training samples may be selectively employed to train the hidden danger point estimation model, so as to obtain different training effects. For example, the management company in the target region may have sufficient management ability to focus on the potential hidden danger points corresponding to a close future (e.g., within the next 30 min, etc.) and a far future (e.g., within the next 90 min-120 min, etc.), and the plurality of training samples from the close future and the far future may be selected to train the hidden danger point estimation model, so as to improve a prediction accuracy of the hidden danger point estimation model in predicting the hidden danger points corresponding to the close future and the far future. For another example, if the management company in the target region does not have the sufficient management ability, the potential hidden danger points corresponding to recent time points may be focused only, and the recent training samples may be selected to train the hidden danger point estimation model to improve the prediction accuracy of the hidden danger point estimation model in predicting the hidden danger points corresponding to recent time points.

Based on the current actual leakage point, the potential hidden danger point to be updated at the future time point may be estimated using a second preset algorithm; and the updated potential hidden danger may be determined based on the determined potential hidden danger point and the potential hidden danger point to be updated.

In some embodiments, the government gas supervision and management platform may estimate the potential hidden danger to be updated at the future time point based on the strong association rule, the current actual leakage point using the second preset algorithm. For example, the government gas regulation and management platform may determine the strong association rule {(x₃, 1)}−{(x₁, −1)}, when x₃ is recognized as the actual leakage point, the position x1 may be determined as the potential hidden danger point to be updated. The manner of determining the potential hidden danger point to be updated may be similar to the manner of determining the actual leakage point to be updated. For more contents about the strong association rule, the second preset algorithm, and the manner of determining the potential hidden danger point to be updated, please refer to related descriptions in FIG. 4.

In some embodiments, the government gas supervision and management platform may determine the updated potential hidden danger point based on the potential hidden danger point and the potential hidden danger point to be updated. In some embodiments, the potential hidden danger points to be updated may be a union of the potential hidden danger points and the potential hidden danger points to be updated.

The prediction of the potential hidden danger points using the hidden danger point estimation model, the prediction accuracy of the potential hidden danger points may be improved, which facilitates the subsequent monitoring of the potential hidden danger points and ensures the safety of the use of gas pipelines.

The basic concepts have been described above, and it is apparent to those skilled in the art that the foregoing detailed disclosure is intended as an example only and does not constitute a limitation of the present disclosure. While not expressly stated herein, a person skilled in the art may make various modifications, improvements, and amendments to the present disclosure. Those types of modifications, improvements, and amendments are suggested in the present disclosure, so those types of modifications, improvements, and amendments remain within the spirit and scope of the exemplary embodiments of the present disclosure.

Also, the present disclosure uses specific words to describe embodiments of the present disclosure. such as “an embodiment,” “an embodiment,” and/or “some embodiment” means a feature, structure, or characteristic associated with at least one embodiment of the present disclosure. Accordingly, it should be emphasized and noted that two or more references to “one embodiment” or “an embodiment” or “an alternative embodiment” in different places in the present disclosure do not necessarily refer to the same embodiment. In addition, certain features, structures, or characteristics in one or more embodiments of the present disclosure may be suitably combined.

Finally, it should be understood that the embodiments described in the present disclosure are only used to illustrate the principles of the embodiments of the present disclosure. Other modifications may also fall within the scope of the present disclosure. As such, alternative configurations of embodiments of the present disclosure may be viewed as consistent with the teachings of the present disclosure as an example, not as a limitation. Correspondingly, the embodiments of the present disclosure are not limited to the embodiments expressly presented and described herein.

What is claimed is:

1. A smart gas pipeline zoning safety supervision method, implemented by a government gas supervision and management platform, the method comprising:
determining a plurality of sub-regions by dividing a target region based on a gas pipeline distribution data in the target region;
obtaining gas sensor data of each point in the plurality of sub-regions on a gas pipeline in the target region from a plurality of gas company management platforms through a government gas supervision sensor network platform;
determining, based on the gas sensor data and pipeline data, an actual leakage point on the gas pipeline;
determining, based on the gas sensor data and a historical maintenance record, a potential hidden danger point on the gas pipeline;
in response to an existence of the actual leakage point, generating, based on an actual position of the actual leakage point on the gas pipeline, a first maintenance instruction and a first adjustment instruction; sending the first maintenance instruction the gas company management platform corresponding to the actual position to instruct the gas company management platform to dispatch maintenance personnel to repair the actual position; and sending the first adjustment instruction to a gas pipeline control device corresponding to the actual position to adjust a working parameter of the gas pipeline control device; and
in response to an existence of the potential hidden danger point, generating, based on a potential position of the potential hidden danger point on the gas pipeline, a second maintenance instruction and a second adjustment instruction; sending the second maintenance instruction to the gas company management platform corresponding to the potential position to instruct the gas company management platform to dispatch the maintenance personnel to check the potential position; and sending the second adjustment instruction to a gas pipeline monitoring device corresponding to the potential position to adjust a monitoring parameter of the gas pipeline monitoring device.

2. The method of claim 1, wherein the determining a plurality of sub-regions by dividing a target region based on a gas pipeline distribution data in the target region includes:
constructing a target pipeline map based on position data and pipeline count data of the gas pipeline in the target region;
generating, based on the target pipeline map, a candidate sub-region division parameter using a first preset algorithm, the candidate sub-region division parameter corresponding to a plurality of groups of gas pipelines corresponding to edges of the target pipeline map;
determining data generation rate and data complexity of the plurality of groups, and determining, based on the data generation rate and the data complexity, a fitness degree of the candidate sub-region division parameter corresponding to each of the plurality of groups;
determining, based on the candidate sub-region division parameter and the corresponding fitness degree, a selected pipeline division parameter;
obtaining the plurality of sub-regions by dividing the gas pipeline based on the selected pipeline division parameter;
determining a management mapping relationship between the plurality of sub-regions and management companies, the management mapping relationship including a management company corresponding to each sub-region; and
generating a routing instruction based on the management mapping relationship and sending the routing instruction to a gas data forwarding device of a gas pipeline network to create a corresponding route.

3. The method of claim 2, wherein the determining a management mapping relationship between the plurality of sub-regions and the management companies includes:
determining a candidate management company corresponding to each of the plurality of sub-regions; and
determining the management company corresponding to each sub-region from the candidate management company based on an evaluation score of the candidate management company and an importance of the sub-region.

4. The method of claim 3, wherein the determining the management company corresponding to each sub-region further includes:
in response to a determination that a replacement condition is satisfied, redetermining the management company corresponding to the sub-region; the replacement condition including that a frequency of abnormal situation in the sub-region under the management of the management company is greater than a preset threshold.

5. The method of claim 1, wherein the determining, based on the gas sensor data and pipeline data, an actual leakage point on the gas pipeline includes:
determining an identification feature based on historical gas sensor data, a historical actual leakage point, historical weather data, and the pipeline data of each point in the plurality of sub-regions, wherein the identification feature represents a data type corresponding to the gas sensor data used to determine whether the gas pipeline has a leakage; and
determining the actual position of the actual leakage point and a leakage result corresponding to each actual leakage point based on the identification feature, current gas sensor data, and the historical gas sensor data, wherein the leakage result includes whether the leakage occurs and a leakage intensity.

6. The method of claim 5, wherein the method further includes:
determining a strong association rule based on a historical potential hidden danger point and the historical actual leakage point through a second preset algorithm;
determining a actual leakage point to be updated and the corresponding actual position based on the strong association rule and a determined potential hidden danger point; and
obtaining an updated actual leakage point by updating the actual leakage point based on the actual leakage point to be updated.

7. The method of claim 5, wherein the method further includes:
estimating, based on the historical maintenance record, the current gas sensor data, the historical potential hidden danger point, the historical actual leakage point, future weather data, and the pipeline data, a potential hidden danger point and an actual occurrence time at a future time point through a hidden danger point estimation model, the hidden danger point estimation model being a machine learning model; wherein,
the hidden danger point estimation model is obtained by a process including: performing an intensive training on an initial hidden danger point estimation model based on a target training sample corresponding to the target region to obtain a trained hidden danger point estimation model;
estimating, based on the current actual leakage point, a potential hidden danger point to be updated at the future time point using a second preset algorithm; and
determining, based on the determined potential hidden danger point and the potential hidden danger point to be updated, an updated potential hidden danger point.

8. The method of claim 7, wherein an input of the hidden danger point estimation model includes:
an evaluation score of the management company corresponding to the sub-region, the evaluation score representing a management ability of the management company.

9. The method of claim 7, wherein the target training sample includes a sample historical maintenance record, sample gas sensor data, a sample historical potential hidden danger point, a sample historical actual leakage point, sample weather data, and sample pipeline data at a first moment; wherein
the target training sample is obtained based on historical data of the target region;
a label corresponding to the target training sample includes the actual leakage point and an actual leakage time at a second moment; wherein the second moment is later than the first moment; and
the target training sample includes a plurality of training samples corresponding to a plurality of different actual leakage times of the label, and
the method further includes:
determining a count of training samples corresponding to each actual leakage time in the target training sample based on the historical leakage frequency, gas company scale data, gas pipeline data, and bandwidth data of the target region.

10. A smart gas pipeline zoning safety supervision Internet of Things (IoT) system, wherein the system includes a government supervision management platform, a government supervision sensor network platform, a government supervision object platform, a gas company sensor network platform, and a gas device object platform that interact in sequence, and the government supervision management platform includes a government gas supervision and management platform and a government safety supervision and management platform;
the government supervision sensor network platform includes a government gas supervision sensor network platform and a government safety supervision sensor network platform;
the government gas supervision and management platform is configured to:
determine a plurality of sub-regions by dividing a target region based on a gas pipeline distribution data in a the target region;
obtain gas sensor data of each point in the plurality of sub-regions on a gas pipeline in the target region from a plurality of gas company management platforms through the government gas supervision sensor network platform;
determine, based on the gas sensor data and pipeline data, an actual leakage point on the gas pipeline;
determine, based on the gas sensor data and a historical maintenance record, a potential hidden danger point on the gas pipeline;
in response to an existence of the actual leakage point, generate, based on an actual position of the actual leakage point on the gas pipeline, a first maintenance instruction and a first adjustment instruction; send the first maintenance instruction to the gas company management platform corresponding to the actual position to instruct the gas company management platform to dispatch maintenance personnel to repair the actual position; and send the first adjustment instruction to the gas pipeline control device corresponding to the actual position to adjust a working parameter of the gas pipeline control device; and
in response to an existence of potential hidden danger point, generate, based on a potential position of the potential hidden danger point on the gas pipeline, a second maintenance instruction and a second adjustment instruction; send the second maintenance instruction to the gas company management platform corresponding to the potential position to instruct the gas company management platform to dispatch the maintenance personnel to check the potential position; and send the second adjustment instruction to a gas pipeline monitoring device corresponding to the potential position to adjust a monitoring parameter of the gas pipeline monitoring device.

11. The IoT system of claim 10, wherein
the gas device object platform also includes the gas pipeline monitoring device, which is deployed in the gas pipeline in the target region and is configured to monitor the gas sensor data in the gas pipeline and upload the gas sensor data to the gas company sensor network platform, and the gas pipeline monitoring device at least includes a temperature sensor, a humidity sensor, a flow rate sensor, and a pressure sensor;
the government supervision object platform at least includes the gas company management platform, and the gas company management platform is configured to:
receive the gas sensor data uploaded by the gas company sensor network platform, and upload the gas sensor data to the government supervision sensor network platform when receiving a data obtaining instruction issued by the government supervision sensor network platform; and
receive the first maintenance instruction and/or the second maintenance instruction issued by the government supervision management platform via the government supervision sensor network platform, generate a dispatch task based on the first maintenance instruction and/or second maintenance instruction, and issue the dispatch task to the maintenance personnel to dispatch the maintenance personnel to perform maintenance on the target sub-region.

12. The IoT system of claim 10, wherein the government gas supervision and management platform is further configured to:
construct a target pipeline map based on position data and pipeline count data of the gas pipeline in the target region;
generate, based on the target pipeline map, a candidate sub-region division parameter using a first preset algorithm, and the candidate sub-region division parameter corresponding to a plurality of groups of gas pipelines corresponding to edges of the target pipeline map;
determine data generation rate and data complexity of the plurality of groups, and determine, based on the data generation rate and the data complexity, a fitness degree of the candidate sub-region division parameter corresponding to each of the plurality of groups;
determine, based on the candidate sub-regions division parameters and the corresponding fitness degree, a selected pipeline division parameter;
obtain the plurality of sub-regions by dividing the gas pipeline based on the selected pipeline division parameter;
determine a management mapping relationship between the plurality of sub-regions and management companies, and the management mapping relationship including a management company corresponding to each sub-region; and
generate a routing instruction based on the management mapping relationship and send the routing instruction to a gas data forwarding device of the gas pipeline network to create a corresponding route.

13. The IoT system of claim 12, wherein the government gas supervision and management platform is further configured to:
determine a candidate management company corresponding to each of the plurality of sub-regions; and
determine the management company corresponding to each sub-region from the candidate management company based on an evaluation score of the candidate management company and an importance of the sub-region.

14. The IoT system of claim 13, wherein the government gas supervision and management platform is further configured to:
in response to a determination that a replacement condition is satisfied, redetermine the management company corresponding to the sub-region; the replacement condition including that a frequency of abnormal situation in the sub-region under the management of the management company is greater than a preset threshold.

15. The IoT system of claim 10, wherein the government gas supervision and management platform is further configured to:
determine an identification feature based on historical gas sensor data, a historical actual leakage point, historical weather data, and the pipeline data of each point in the plurality of sub-regions, wherein the identification feature represents a data type corresponding to the gas sensor data used to determine whether the gas pipeline has a leakage; and
determine the actual position of the actual leakage point and a leakage result corresponding to each actual leakage point based on the identification feature, current gas sensor data, and the historical gas sensor data, wherein the leakage result includes whether the leakage occurs and a leakage intensity.

16. The IoT system of claim 15, wherein the government gas supervision and management platform is further configured to:
determine a strong association rule based on a historical potential hidden danger point and the historical actual leakage point through a second preset algorithm;
determine a actual leakage point to be updated and the corresponding actual position based on the strong association rule and a determined potential hidden danger point; and
obtain an updated actual leakage point by updating the actual leakage point based on the actual leakage point to be updated.

17. The IoT system of claim 15, wherein the government gas supervision and management platform is further configured to:
estimate, based on the historical maintenance record, the current gas sensor data, the historical potential hidden danger point, the historical actual leakage point, future weather data, and the pipeline data, a potential hidden danger point and an actual leakage time at a future time point through the hidden danger point estimation mode, the hidden danger point estimation mode being a machine learning model; wherein,
the hidden danger point estimation mode is obtained by a process including: performing an intensive training on an initial hidden danger point estimation model based on a target training sample corresponding to the target region, to obtain a trained hidden danger point estimation mode;
estimating, based on the current actual leakage point, a potential hidden danger point to be updated at the future time point using a second preset algorithm; and
determine, based on the determined potential hidden danger point and the potential hidden danger point to be updated, an updated potential hidden danger point.

18. The IoT system of claim 17, wherein an input of the hidden danger point estimation mode includes:
an evaluation score of the management company corresponding to the sub-region, the evaluation score representing a management ability of the management company.

19. The IoT system of claim 17, wherein the target training sample includes a sample historical maintenance record, sample gas sensor data, a sample historical potential hidden danger point, a sample historical actual leakage point, sample weather data, and sample pipeline data at a first moment; wherein
the target training sample is obtained based on historical data of the target region;
a label corresponding to the target training sample includes the actual leakage point and an actual leakage time at a second moment; wherein the second moment is later than the first moment; and
the target training sample include a plurality of training samples corresponding to a plurality of different actual leakage times of the label, and
the method further includes:
determining a count of training samples corresponding to each actual leakage time in the target training sample based on the historical leakage frequency, gas company scale data, gas pipeline data, and bandwidth data of the target region.

20. A non-transitory computer-readable storage medium storing computer instructions, wherein when executing the computer instructions in the non-transitory computer-readable storage medium, a computer implements the smart gas pipeline zoning safety supervision method according to claim 1.
